(19) United States
(12) Patent Application Publication
(10) Pub. No.: US 2020/0118445 A1
(43) Pub. Date: Apr. 16, 2020

(54) METHOD AND APPARATUS FOR RECEIVING OF DRIVING DATA IN PLATOONING IN AUTONOMOUS DRIVING SYSTEM

(71) Applicant: LG Electronics Inc., Seoul (KR)

(72) Inventor: Cheol Seung KIM, Seoul (KR)

(21) Appl. No.: 16/713,599

(22) Filed: Dec. 13, 2019

(30) Foreign Application Priority Data
Aug. 19, 2019 (KR) 10-2019-0100809

(51) Int. Cl. G08G 1/00; H04W 4/46; G06F 3/0482; H04W 4/06

(52) U.S. Cl. CPC G08G 1/22; H04W 4/06; G06F 3/0482; H04W 4/46

(57) ABSTRACT

Disclosed herein is a method of receiving driving data in platooning in an autonomous driving system. The method includes transmitting a platooning request message to a leader vehicle of a platoon in which a vehicle is to join, receiving a platooning response message as a response to the platooning request message, transmitting information of the driving data to the leader vehicle, and receiving a list of the driving data related to vehicles of the platoon from the leader vehicle, so that the platooning vehicle can receive driving data from another vehicle in a platoon. One or more of an autonomous vehicle, a user terminal and a server of the present disclosure can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATION

This application claims the benefit of Korean Patent Application No. 10-2019-0100809, filed on Aug. 19, 2019. The contents of this application are hereby incorporated by reference in its entirety.

### BACKGROUND OF THE INVENTION

### Field of the Invention

The present disclosure relates to an autonomous driving system and, more particularly, to a method and apparatus in which a platooning vehicle receives driving data from another vehicle in a platoon.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

An object of the present disclosure is to propose a method and apparatus for receiving driving data in platooning.

Another object of the present disclosure is to propose a method and apparatus in which a platooning vehicle receives driving data from another vehicle in a platoon.

The technical objects which are to be achieved by the present disclosure are not limited to the above-mentioned technical objects, and other technical objects which are not mentioned above will be clearly understood by those skilled in the art from the following detailed description of the present disclosure.

In an aspect, a method of receiving driving data in platooning in an autonomous driving system may include transmitting a platooning request message to a leader vehicle of a platoon in which a vehicle is to join; receiving a platooning response message as a response to the platooning request message; transmitting information of the driving data to the leader vehicle; and receiving a list of the driving data related to vehicles of the platoon from the leader vehicle, wherein the list may instruct the information of the driving data that may be transmitted by the vehicles of the platoon, and the information of the driving data may include an identifier of the vehicle generating the driving data, an identifier of the driving data, and a generating section.

The leader vehicle may transmit the list through a Groupcast to member vehicles of the group.

The method may further include determining required driving data based on the list; establishing a Unicast link based on the required driving data; and receiving the required driving data through the Unicast link, wherein the Unicast link may be established by forming a Peer with a transmission vehicle that may transmit the required driving data.

The establishing of the Unicast link may be established by transmitting a communication request message including the identifier of the transmission vehicle through a Broadcast, and responding to the communication request message through a Unicast by the transmission vehicle.

The receiving of the required driving data may be performed by giving a coin related to a block chain to the transmission vehicle.

The method may further include updating the information of the driving data based on the required driving data, wherein the vehicle may update the driving data using the required driving data.

The determining of the required driving data may be performed by displaying the list on a display and accepting selection of the required driving data from a user.

The method may further include transmitting the updated driving data information to the leader vehicle, wherein the leader vehicle may update the list based on the updated driving data information.

A number of coins may be based on the generating section.

The leader vehicle may determine a Source Layer-2 ID and a Destination Layer-2 ID instructing the member vehicles.

In another aspect, a vehicle for performing a method of receiving driving data in platooning in an autonomous driving system may include a communication module; a display; a memory; and a processor configured to control the communication module, the display and the memory, wherein the processor transmits a platooning request message to a leader vehicle of a group in which a vehicle is to join, receives a platooning response message as a response to the platooning request message, transmits information of the driving data to the leader vehicle, and receives a list of the driving data related to vehicles of the group from the leader vehicle, through the communication module, wherein the list instructs the information of the driving data that may be transmitted by the vehicles of the group, and the information of the driving data may include an identifier of the vehicle generating the driving data, an identifier of the driving data, and a generating section.

According to an embodiment of the present disclosure, it is possible to receive or purchase driving data in platooning.

Further, according to an embodiment of the present disclosure, a platooning vehicle can receive or purchase driving data from another vehicle in a group.

Effects which are to be achieved by the present disclosure are not limited to the above-mentioned effects, and other effects which are not mentioned above will be clearly understood by those skilled in the art from the following detailed description.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram for describing a use scenario of a user according to an embodiment of the present disclosure.

FIG. 10 illustrates V2X communication to which the present disclosure is applicable.

FIGS. 11A and 11B illustrate a resource allocation method in a sidelink in which V2X is used.

FIG. 12 is a diagram illustrating a procedure for a broadcast mode of V2X communication using PC5.

FIG. 13 is a diagram illustrating a procedure for a groupcast mode of V2X communication using PC5.

FIG. 14 is a diagram illustrating a procedure for a groupcast mode of V2X communication using PC5.

FIG. 15 illustrates a block chain applicable to the present disclosure.

FIGS. 16A and 16B illustrate a block chain applicable to the present disclosure.

FIG. 17 illustrates a block chain having an autonomous vehicle as a node.

FIG. 18 is an embodiment applicable to the present disclosure.

FIG. 19 is an embodiment of a vehicle to which the present disclosure is applicable.

FIG. 20 illustrates a general apparatus to which the present disclosure is applicable.

The accompanying drawings, which are included as a part of the detailed description to provide the thorough understanding of the present invention, provide an embodiment of the present invention and describe the technical features of the present invention together with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

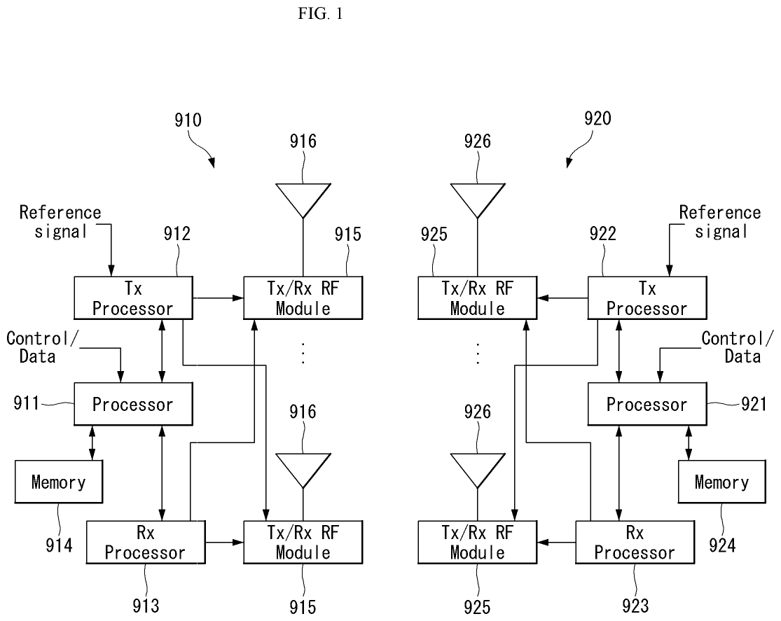

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

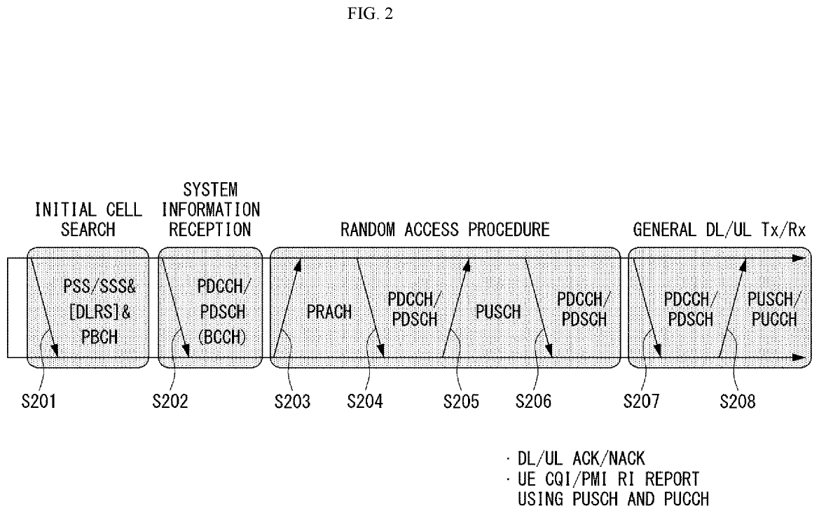

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to “beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) returning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

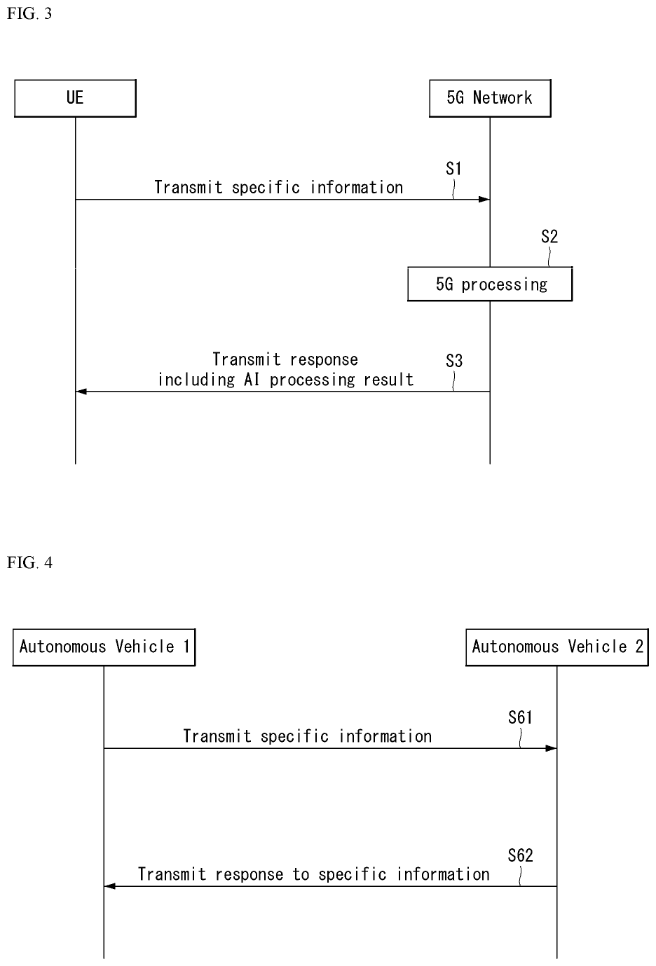

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

Driving

(1) Exterior of Vehicle

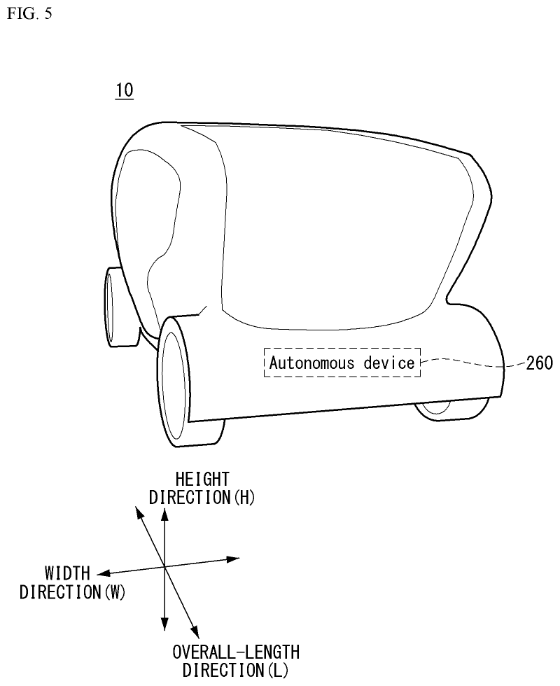

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

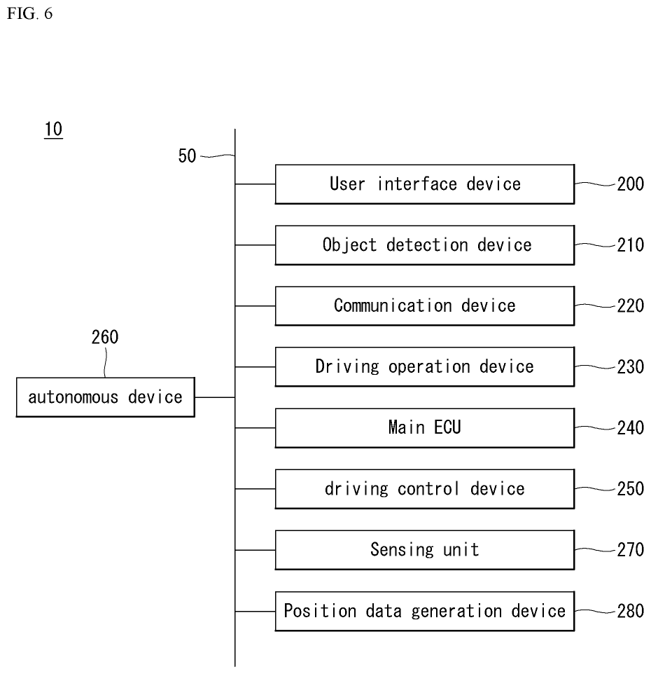

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

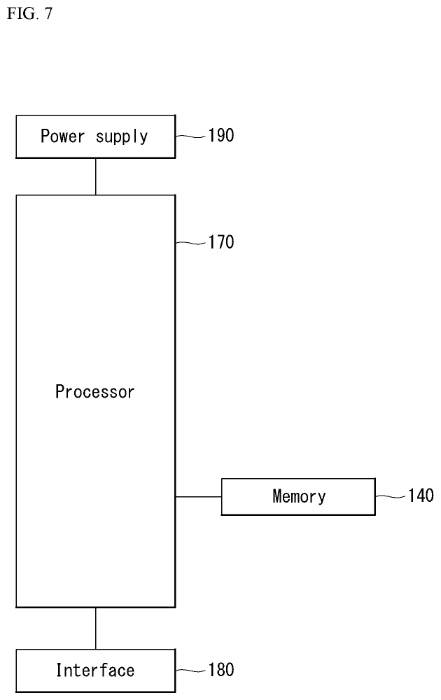

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

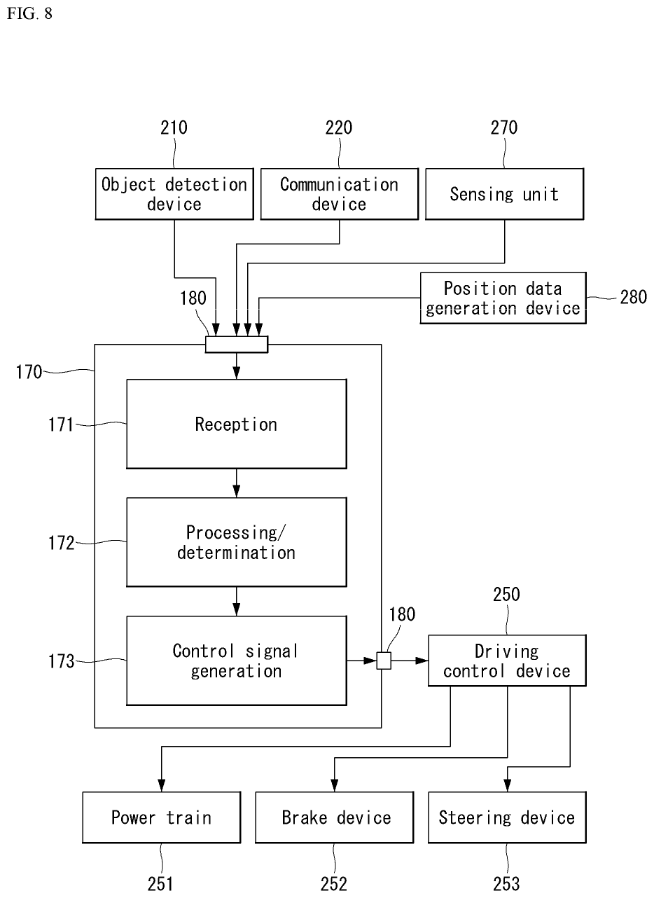

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenarios

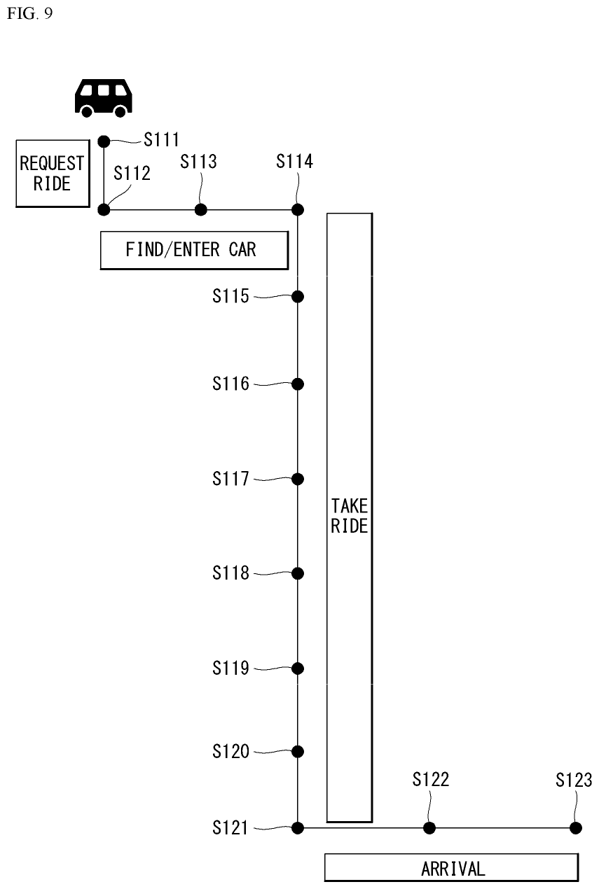

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system may further include at least one guide light. The guide light can be disposed on the floor of the cabin. When a user riding in the vehicle is detected, the cabin system can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

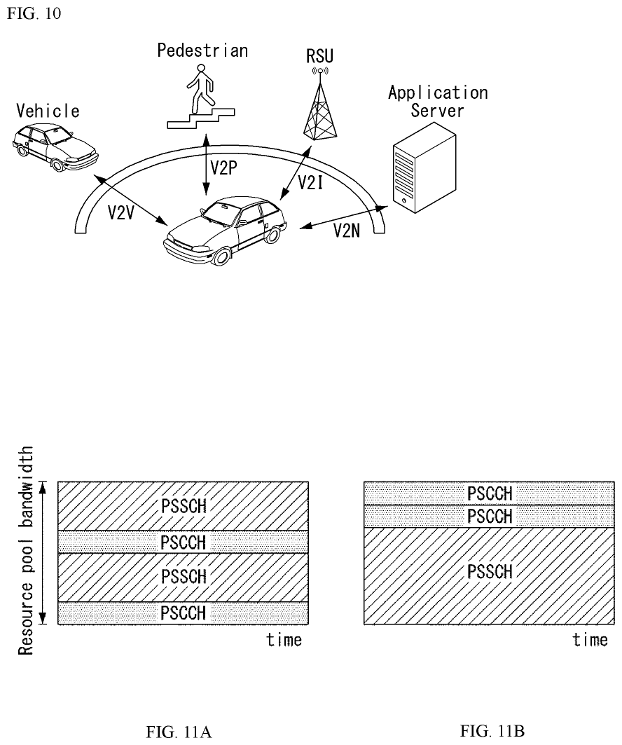

FIG. 10 illustrates V2X communication to which the present disclosure is applicable.

V2X communication includes communication between a vehicle and any entity, such as V2V (Vehicle-to-Vehicle) referring to communication between vehicles, V2I (Vehicle to Infrastructure) referring to communication between a vehicle and an eNB or a road side unit (RSU), V2P (Vehicle-to-Pedestrian) referring to communication between a vehicle and a UE carried by a person (a pedestrian, a bicycle driver, or a vehicle driver or passenger), and V2N (vehicle-to-network).

V2X communication may refer to the same meaning as V2X sidelink or NR V2X or refer to a wider meaning including V2X sidelink or NR V2X.

V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

V2X communication can be provided through a PC5 interface and/or a Uu interface. In this case, specific network entities for supporting communication between vehicles and every entity can be present in wireless communication systems supporting V2X communication. For example, the network entities may be a BS (eNB), a road side unit (RSU), a UE, an application server (e.g., traffic safety server) and the like.

Further, a UE which performs V2X communication may refer to a vehicle UE (V-UE), a pedestrian UE, a BS type (eNB type) RSU, a UE type RSU and a robot including a communication module as well as a handheld UE.

V2X communication can be directly performed between UEs or performed through the network entities. V2X operation modes can be categorized according to V2X communication execution methods.

V2X communication is required to support pseudonymity and privacy of UEs when a V2X application is used such that an operator or a third party cannot track a UE identifier within an area in which V2X is supported.

The terms frequently used in V2X communication are defined as follows.
RSU (Road Side Unit): RSU is a V2X service enabled device which can perform transmission/reception to/from moving vehicles using a V2I service. In addition, the RSU is a fixed infrastructure entity supporting a V2X application and can exchange messages with other entities supporting the V2X application. The RSU is a term frequently used in conventional ITS specifications and is introduced to 3GPP specifications in order to allow documents to be able to be read more easily in ITS industry. The RSU is a logical entity which combines V2X application logic with the function of a BS (BS-type RSU) or a UE (UE-type RSU).
V2I service: A type of V2X service having a vehicle as one side and an entity belonging to infrastructures as the other side.
V2P service: A type of V2X service having a vehicle as one side and a device carried by a person (e.g., a pedestrian, a bicycle rider, a driver or a handheld UE device carried by a fellow passenger) as the other side.
V2X service: A 3GPP communication service type related to a device performing transmission/reception to/from a vehicle.
V2X enabled UE: UE supporting V2X service.
V2V service: A V2X service type having vehicles as both sides.
V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V2P) as described above.

FIGS. 11A and 11B illustrate a resource allocation method in siderink in which V2X is used.

On sidelink, different physical sidelink control channels (PSCCHs) may be spaced and allocated in the frequency domain and different physical sidelink shared channels (PSSCHs) may be spaced and allocated. Alternatively, different PSCCHs may be continuously allocated in the frequency domain and PSSCHs may also be continuously allocated in the frequency domain.

NR V2X

To extend 3GPP platform to auto industry during 3GPP release 14 and 15, support for V2V and V2X services has been introduced in LTE.

Requirements for support for enhanced V2X use cases are arranged into four use example groups.

(1) Vehicle platooning enables dynamic formation of a platoon in which vehicles move together. All vehicles in a platoon obtain information from the leading vehicle in order to manage the platoon. Such information allows vehicles to travel in harmony rather than traveling in a normal direction and to move together in the same direction.

(2) Extended sensors allow vehicles, road side units, pedestrian devices and V2X application servers to exchange raw data or processed data collected through local sensors or live video images. A vehicle can enhance recognition of environment beyond a level that can be detected by a sensor thereof and can ascertain local circumstances more extensively and generally. A high data transfer rate is one of major characteristics.

(3) Advanced driving enables semi-automatic or full-automatic driving. Each vehicle and/or RSU share data recognized thereby and obtained from local sensors with a neighboring vehicle, and a vehicle can synchronize and adjust a trajectory or maneuver. Each vehicle shares driving intention with a neighboring traveling vehicle.

(4) Remote driving enables a remote driver or a V2X application to drive a remote vehicle for a passenger who cannot drive or cannot drive a remote vehicle in a dangerous environment. When changes are limited and routes can be predicted such as public transportation, driving based on cloud computing can be used. High reliability and low latency time are major requirements.

ID for Performing V2X Communication Through PC5

Each UE has a Layer-2 identifier for V2X communication through at least one PC5. The Layer-2 identifier includes a source Layer-2 ID and a destination Layer-2 ID.

The source and destination Layer-2 IDs are included in a Layer-2 frame, and the Layer-2 frame is transmitted through a layer-2 link of PC5 which identifies a source and a destination of Layer-2.

A UE selects source and destination Layer-2 ID on the basis of a communication mode of V2X communication of PC5 of Layer-2 link. Different communication modes may have different source Layer-2 IDs.

When IP-based V2X communication is permitted, a UE is set such that it uses a link local IPv6 address as a source IP address. The UE can use this IP address for V2X communication of PC5 without sending a Neighbor Solicitation and Neighbor Advertisement message for duplicate address search.

If one UE has an activated V2X application that is supported in the current geographical area and requires personal information protection, a source Layer-2 ID may be changed over time and randomized such that a source UE (e.g., a vehicle) is traced or distinguished from other UEs only for a specific time. In the case of IP-based V2X communication, a source IP address needs to be changed over time and randomized.

Changes of IDs of a source UE need to be synchronized in a layer used in PC5. That is, if an application layer ID is changed, a source Layer-2 ID and a source IP address also need to be changed.

1. Identifier for Broadcast Mode V2X Communication

For a broadcast mode of V2X communication through PC5, the UE is set to a destination Layer-2 ID for using a V2X service. The destination Layer-2 ID to be used for the V2X service is selected according to a configuration as described in 5.1.2.1 of the 3GPP 23.287 document.

The UE self-selects the source Layer-2 ID. The UE may use different source Layer-2 IDs according to different types of PC5 reference points (i.e., LTE-based PC5, NR-based PC5).

2. Identifier for Groupcast Mode V2X Communication

For a groupcast mode of V2X communication via PC5, a V2X application layer may provide group identifier information. When the group identifier information is provided by the V2X application layer, the UE converts the provided group identifier into a destination Layer-2 ID. If the group identifier information is not provided by the V2X application layer, the UE determines the destination Layer-2 ID according to a mapping configuration between service types as described in 5.1.2.1 of the 3GPP 23.287 document. The UE self-selects the source Layer-2 ID.

3. Identifier for Unicast Mode V2X Communication

For a unicast mode of V2X communication over PC5, the destination Layer-2 ID is used on the basis of a communication peer discovered during establishment of a unicast link. Initial signaling for establishing a unicast link may use a default destination Layer-2 ID associated with a service type (i.e., PSID/ITS-AID) configured for establishing the unicast link. During the unicast link establishment procedure, Layer-2 IDs are exchanged and used in subsequent communication between the two UEs.

An Application Layer ID is associated with one or more V2X applications of the UE. If the UE has one or more Application Layer IDs, each Application Layer ID of the same UE may be viewed as an Application Layer ID of a different UE from the perspective of a peer UE.

Since the V2X application layer does not use Layer-2 IDs, the UE must maintain mapping between Application Layer IDs and source Layer-2 IDs used in the unicast link. This allows V2X applications to change the source Layer-2 ID without interruption.

When the Application Layer ID is changed, if a link is used for V2X communication with the changed Application Layer ID, the source Layer-2 ID of the unicast link is changed.

The UE may establish a plurality of unicast links with the peer UE, and may use the same or different source Layer-2 ID for the unicast link.

Broadcast Mode

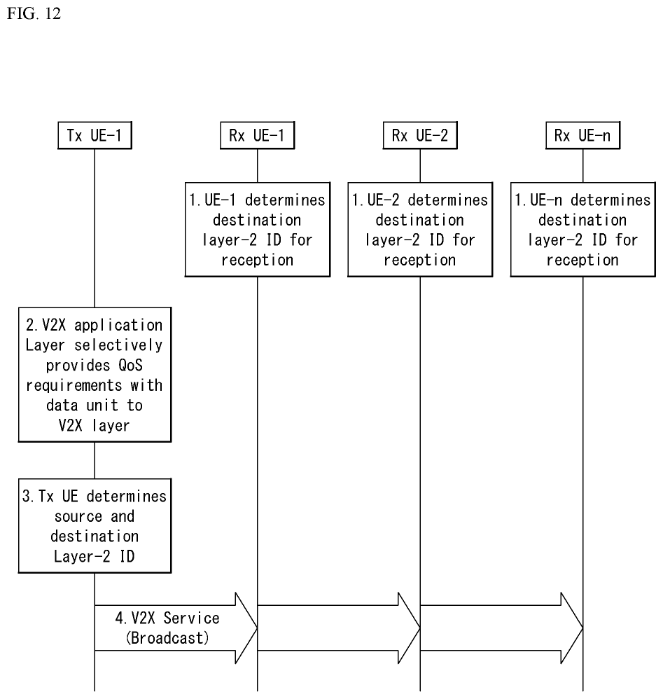

FIG. 12 is a view illustrating a procedure for a broadcast mode of V2X communication using PC5.

1. A receiving UE determines a destination Layer-2 ID for broadcast reception. The destination Layer-2 ID is transmitted to an AS layer of the receiving UE for reception.

2. A V2X application layer of a transmitting UE may provide a data unit and provide V2X application requirements.

3. The transmitting UE determines the destination Layer-2 ID for broadcast. The transmitting UE self-assigns a source Layer-2 ID.

4. One broadcast message transmitted by the transmitting UE transmits V2X service data using the source Layer-2 ID and the destination Layer-2 ID.

Groupcast Mode

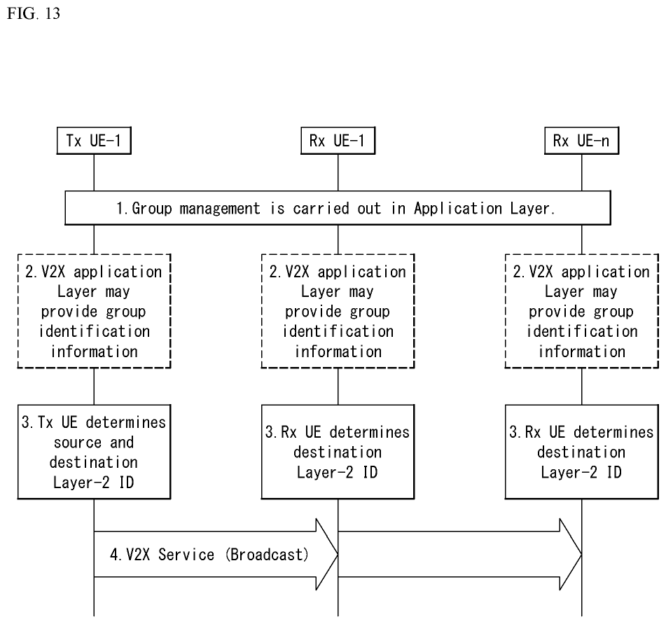

FIG. 13 is a view illustrating a procedure for a groupcast mode of V2X communication using PC5.

1. V2X group management is performed through a V2X application layer.

2. The V2X application layer may provide a group identifier as described in 5.6.1.3 of the 3GPP 23.287 document. In addition, the V2X application layer may provide service requirements for communication.

3. The transmitting UE determines the source Layer-2 ID and the destination Layer-2 ID, and the receiving UE determines the destination Layer-2 ID. The destination Layer-2 ID is delivered to an AS layer of the receiving UE for group communication transmission. The transmitting UE determines a PC5 QoS parameter for groupcast.

4. The transmitting UE has a V2X service related to group communication. In addition, the transmitting UE transmits V2X service data using the source Layer-2 ID and the destination Layer-2 ID.

The transmitting UE at step 4 has only one groupcast message.

Unicast Mode

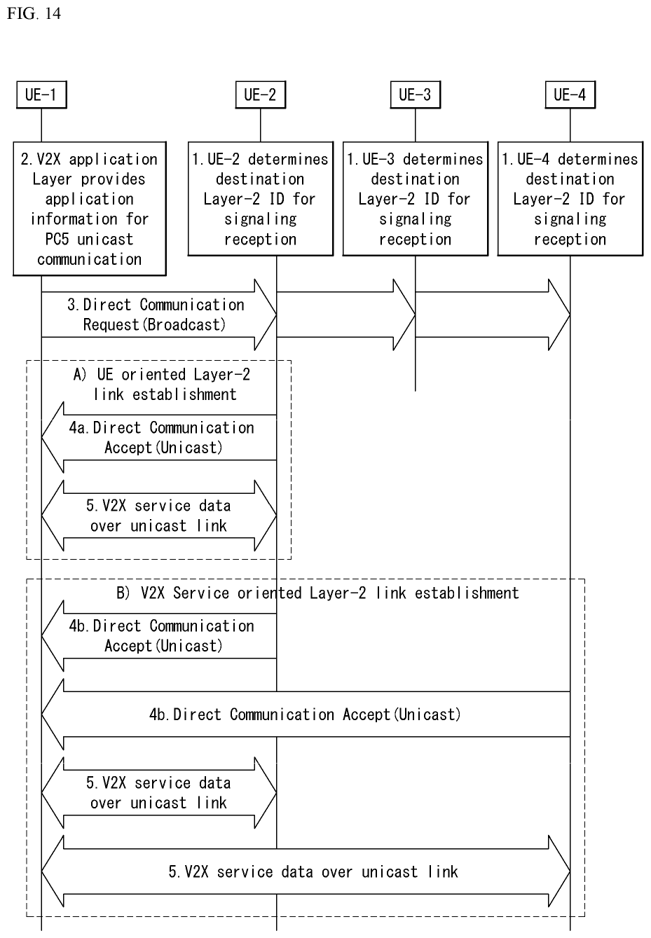

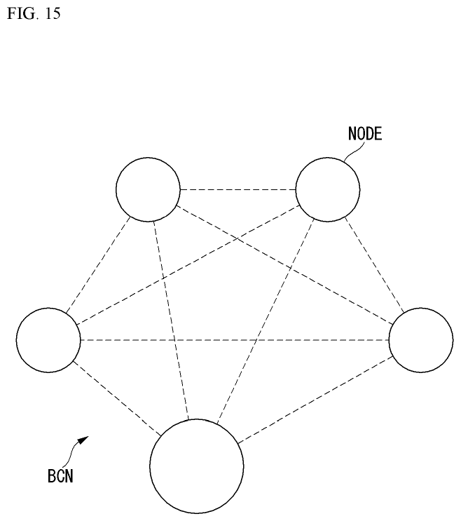

FIG. 14 is a view illustrating a procedure for unicast mode of V2X communication using PC5.

1. The UE determines a destination Layer-2 ID for receiving signaling for establishing a PC5 unicast link.

2. A V2X application layer of the UE-1 provides application information for PC5 unicast communication. The application information includes the service type (e.g., PSID or ITS-AID) of the V2X application and an initiating UE's Application Layer ID.

The application layer ID of the target UE may be included in the application information. The V2X application layer of the UE-1 may provide service requirements for the corresponding unicast communication. The UE-1 determines a PC5 QoS parameter and PFI.

If the UE-1 determines to reuse the existing PC5 unicast link, the UE triggers a Layer-2 link modification procedure.

3. The UE-1 transmits a Direct Communication Request message to initiate a unicast layer-2 link establishment procedure. The Direct Communication Request message includes the following:
Source User Info: Application Layer ID of the initiating UE (i.e., Application Layer ID of the UE-1)
If the V2X application layer provides a target UE Application Layer ID of step 2, the following information is included.

Target User Info: Application Layer ID of the target UE (i.e., Application Layer ID of UE-2)
V2X Service Info: Information on a V2X Service requesting establishment of a Layer-2 link (e.g., PSID or ITS-AID).
Indication of whether to use IP communication
IP Address Configuration: IP address configuration required for such a link in IP communication (Details of the IP address configuration are FFS)
QoS Info: Information about PC5 QoS Flow. PFI and corresponding PC5 QoS parameter for each PC5 QoS Flow (i.e. conditionally other parameters such as PQI and MFBR/GFBR, etc.) (Whether QoS information exchange is required is FFS)

The UE-1 transmits a direct communication request message through PC5 broadcast by using a source layer-2 ID and a destination layer-2 ID.

4. Direct Communication Accept message is transmitted to UE-1 as follows.

4a. (Establishing Layer-2 link directed to the UE) If the Target User Info is included in the Direct Communication Request message, it is transmitted to the target UE (i.e., the UE-2 responds with a Direct Communication Accept message).

4b. (Establishing Layer-2 link directed to V2X service) If Target User Info is not included in the Direct Communication Request message, it is transmitted to a UE interested in using a known V2X service. To determine to establish a Layer-2 link, it responds to a request from the UE-1 by sending a Direct Communication Accept message (UE-2 and UE-4).

The Direct Communication Accept message includes the following:
Source User Info: Application Layer ID of UE for transmitting Direct Communication Accept message
QoS Info: information on PC5 QoS Flow. PFI and corresponding PC5 QoS parameters for each PC5 QoS Flow (i.e. conditionally different parameters such as PQI and MFBR/GFBR, etc.)

The destination Layer-2 ID is set to the source Layer-2 ID of the received Direct Communication Request message.

When the Direct Communication Accept message is received from the peer UE, the UE-1 obtains a Layer-2 ID of the peer UE used for future communication for signaling and data traffic for the unicast link.

The V2X layer of the UE that establishes the PC5 unicast link delivers the unicast link and the PC5 Link Identifier assigned to the information related to the unicast link to the AS layer. The information related to the PC5 unicast link includes Layer-2 ID information (i.e., Source Layer-2 ID and Destination Layer-2 ID). Through this, the AS layer may maintain the PC5 Link Identifier with information associated with the PC5 unicast link.

5. V2X service data is transmitted via unicast link established as follows:

The PC5 Link Identifier and the PFI are provided to the AS layer along with the V2X service data.

The UE-1 transmits V2X service data using the source Layer-2 ID and the destination Layer-2 ID (i.e., the Layer-2 ID of the peer UE for the unicast link).

Since the PC5 unicast link is bidirectional, the peer UE of the UE-1 may transmit V2X service data to the UE-1 through the unicast link.

The 5G communication technology described above may be applied in combination with the methods proposed in the present disclosure to be described later, or may be supplemented to specify or clarify the technical features of the methods proposed in the present disclosure.

Hereinafter, various embodiments of the present disclosure will be described in detail with reference to the accompanying drawings.

FIG. 15 illustrates a block chain applicable to the present disclosure.

The block chain is a computing technology that is designed such that all members verify, store and execute information and values through a network, thus preventing arbitrary manipulation by a malicious group.

The core technology of the block chain is a structure in which transaction records or information is individually stored without the aid of a third group (Clearing House or Trusted Third Party (TTP)), and transactions are achieved only when members are jointly authenticated. The block chain is a block assembly that connects blocks containing multiple transaction records and pieces of information, and is a chain structure where each block is organically connected to a preceding block via a Hash Value to extend to a genesis block.

In this regard, the block refers to a kind of data packet that is made by encrypting the information in the form of letters or figures and then sequentially connecting the encrypted information. Blocks containing new information are connected at regular intervals, and it is possible to prevent the forgery of information in the block chain by verifying validity in the process of connecting the blocks to each other.

The kind of the block chain includes a Public Block Chain, a Private Block Chain, a Consortium Block Chain, etc.

The public block chain is an initial block chain utilization case, which may be opened to and operated by everyone through the Internet, allows everyone to join authentication, and has the property of having mutual anonymity. The private block chain is a personal block chain, which may be accessed only by an authorized user. One subject may manage an internal network as the block chain, and may provide a platform service for a relevant chain development. The consortium block chain is a semi-central block chain where only a small number of pre-selected subjects may join. This allows the subjects to join authentication through a rule agreed among the subjects, and has excellent network scalability.

Herein, the term “block chain” collectively refers to the public block chain, the private block chain or the consortium block chain.

The core technology of the block chain is composed of four generic technologies, namely, a P2P (Peer-to-Peer) network, encryption, a distributed ledger and distributed consensus. These technologies are complementary to realize decentralization, data integrity maintenance, etc. Hereinafter, the block chain technology combined with the core technology of the block chain and the autonomous driving technology of the vehicle will be described.

P2P Network

The communication and connection between participants of the block chain may be performed based on a P2P network. The P2P network is defined as an autonomous configuration system composed of an autonomous object (Peer) with an equivalent qualification for the purpose of sharing distributed resources without the concept of centralized services.

The P2P network is mainly classified into a structured P2P and an unstructured P2P. The unstructured P2P may be divided into a ‘centralized P2P network’ where the network is formed between the participants around the server, and a ‘distributed P2P network’ based on the flooding algorithm of data. The block chain may use a flooding-based unstructured P2P network to implement the decentralization distributed network, but is not limited thereto.

The main characteristics of the P2P network are as follows. In terms of distributed resource sharing, the resource of interest may be used in a distributed form and may be located at a network end close to the peer. Each peer in a peer set uses the resource provided by an opponent peer, and a target resource includes audio/video data, an application, computing power, a computing resource and the like. The peers are interconnected via the network, and may be distributed all over the global. In terms of a distributed autonomous organization, the peers interact directly with each other without any centralized control or intervention for using the shared resource. In terms of performance, it is sometimes necessary to introduce a centralization element into the P2P network of a complete distribution concept. This is called a hybrid P2P network. To this end, the server may be used as the centralization element, and in particular, a Mobile Edge Computing (MEC) server may play this role. Furthermore, the hybrid P2P network with a specific peer as the centralization element may be configured. In the P2P network, each peer acts as both a client and a server to provide flexibility in terms of functional availability. Furthermore, each peer has an equivalent qualification in terms of a functional role. The sharing of resources held by the respective peers depends on the autonomous decision of the peers. Particularly, in the present disclosure, the respective peers may be configured as the autonomous vehicle.

Encryption

As the encryption technology used in the block chain, Merkle Tree technique and public key-based Digital Signature technique may be used.

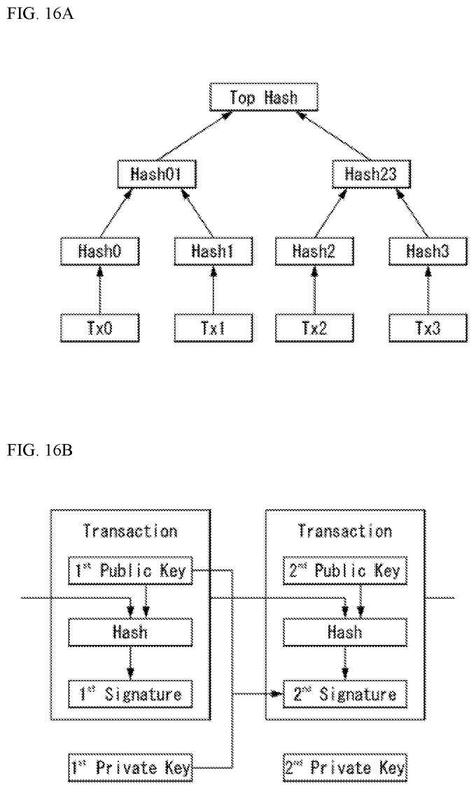

FIG. 16A is a view illustrating the Merkle Tree technique in the block chain encryption technology.

Referring to FIG. 16A, the Merkle Tree is a kind of hash tree and refers to a tree in which the names of all non-leaf nodes are composed of a hash of children nodes. A leaf node means a file or data of a specific value, and a parent node is composed of a hash of the leaf node. A root node of the Merkle Tree configured in this way may be composed of the hash value of the data of all nodes constituting the tree. In this case, a user may verify the forgery of the data merely by verifying the hash of the root node. Therefore, the foundation of the Merkle Tree may be formed by inserting transaction information between participants into the left node in the block chain. The function used to generate the Merkle Tree is SHA-256, but the configuration of the present disclosure is not limited thereto.

FIG. 16B is a view illustrating the public key-based Digital Signature technique in the block chain encryption technology.

Referring to FIG. 16B, the public key-based Digital Signature technique is encryption technology that enables safe communication between participants who do not previously share a secret key, and is used in a field such as identity authentication. In the public key-based structure, the public key and the secret key exist. Here, all participants know the public key, but only an owner knows the secret key. A user signs the transaction using his or her secret key and transmits the transaction information to the block chain network along with the user's public key corresponding thereto. Subsequently, other participants may verify the validity of the transaction through a sender's public key.

Distributed Ledger

The distributed ledger is a memory of information that is replicated, shared and synchronized by a consensus between participants. In order for the distributed ledger to be applied to the P2P network, the agreement of the participants is required, and the same applies to the block chain. In the block chain, the distributed ledger may store all the generated information through the verification of the participants, and all participants may maintain the same information. When verifying the information, the connectivity with the information recorded in the distributed ledger maintained by each participant is checked, and only legal information is stored in the distributed ledger of the block chain by the consensus of the participants.

The information is accumulated for a predetermined time to be stored on the basis of a block, and is stored in the distributed ledger with the connectivity between the blocks. The distributed ledger is the basis for the integrity of the data provided by the block chain. Users participating in the block chain own the data of the same distributed ledger, and may show better security effects from external hacking or manipulation of a specific user. For example, if a hacker from the outside attempts to forge specific data or to do a double transaction, the hacker should try to hack a majority of the distributed ledger owned by the participants, which consumes high cost and computing resource.

Distributed Consensus

The distributed consensus is a protocol that obtains agreement for specific data between processes or agents when there are processes that are combined in the field of distributed computing and multi-agent systems. The distributed consensus protocol has the properties of validity, integrity, agreement, and termination.

The consensus algorithm may use a Proof of Work (PoW) algorithm, a Proof of Stake (PoS) algorithm, a Delegated Proof of Stake (DPoS) algorithm, a Practical Byzantine Fault Tolerance (PBFT) algorithm, a Proof of Elapsed Time (PoET) algorithm, a Proof of Importance algorithm, a Proof of Authority (PoA) algorithm, etc. In addition, other designed algorithms may be used.

Autonomous Driving of Vehicle Using Block Chain

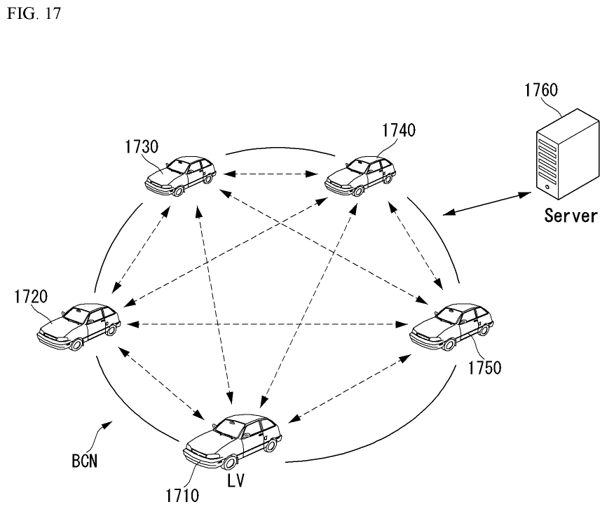

FIG. 17 illustrates a block chain having an autonomous vehicle as a node.

In first- and second-generation block chains, only cryptocurrency or simple transaction records are recorded and used in the block. In a third-generation block chain, since processing speed is increased and a storage capacity is increased, data and a programming code are added to generate data. Therefore, the block chain may be used in the autonomous driving of the vehicle or the IoT as well as financial transactions.

However, the block chain is too low in scalability to be directly applied to a vehicle system, and may be low in processing capacity. Thus, a lightweight block chain may be used in the autonomous vehicle or the IoT (Internet of Things). As the lightweight block chain system, there is a Lightweight Scalable Block chain (LSB). The LSB is intended for a large-scale network environment composed of nodes having limited calculation ability such as the IoT, and at least one autonomous vehicle or IoT may join. A predetermined number of nodes on the LSB network gather to form one cluster and one node functions as a cluster head. Here, the cluster head may generate and store the block of the block chain.

Other nodes participating in the cluster may perform only the verification of the stored block. The node corresponding to the cluster head in the LSB may be referred to as an Overlay Block Manager (OBM). The transactions forming the block chain are transmitted and received between OBMs and are verified, and have no central control system as in a general block chain. Indeed, in the LSB, only the OBM participates in the block chain, and other nodes take a centralized management method about the OBM. Such a network is referred to as an Overlay Network.

Particularly, the block chain may be used in the platooning technology of a plurality of vehicles. If the plurality of vehicles is platooned, the vehicles may form one network and may be driven while maintaining a constant distance between the vehicles. The vehicles forming a group may receive peripheral information through V2X (Vehicle to Everything) communication and may be used for safe driving. In the platooning, a leader vehicle 1710 may be referred to as a LV (Leading Vehicle), and host vehicles 1720, 1730, 1740, 1750 . . . following the leader vehicle may be referred to as a SV (Slave Vehicle) or a FV (Following Vehicle). Herein, the leading vehicle may be used along with a “leader vehicle”, and the slave vehicle or the following vehicle may be used along with a “member vehicle”.

In the platooning system using the block chain, a plurality of platooning vehicles may be viewed as the node of the block chain. The vehicles may block data generated from the vehicles and transmit the data to other platooning vehicles. The generated data may be transmitted to a Cloud Server or a MEC server (Mobile Edge Computing Server). Consequently, even when at least one vehicle which is currently being platooned or has been platooned in the past is hacked or the data of the vehicle is forged by a user, it is possible to check original data through the cloud server or the MEC server.

In this case, the data transmitting/receiving scheme between the platooning vehicles may include Broadcast, Groupcast, Unicast and the like.

In an embodiment of the present disclosure, the block chain system may include a block chain network (BCN) and a server.

The block chain network BCN may be composed of at least one node. The node may be a server 1760, a vehicle or other IoT devices. The node may record information based on a preset rule, may transmit the recorded information to each block chain server 1760, and simultaneously the server 1760 may store and manage the received information. Each node may mean an autonomous vehicle.

In various embodiments of the present disclosure, the node may record information based on the preset rule, and may also perform the function of the server 1760. To be more specific, each node may add a programming code to generate or store the data.

In an embodiment of the present disclosure, the server 1760 may include the cloud server or the MEC server. The server 1760 may receive the transaction information from the vehicle to store and manage it. The transaction information may mean information about various events performed based on the block chain. Particularly, in the present disclosure, the transaction may be an event related to internal and external vehicle information acquired by the autonomous vehicle through a sensing unit.

In the case of using the network of the autonomous vehicle with the block chain, the internal and external vehicle information acquired by each vehicle may replicate, share or synchronize the server 1660 or the memory of another vehicle. Due to the sharing of the information, the vehicle can effectively respond to information manipulation by external hacking or information manipulation by a user.

When a vehicle that is to create a 3D HD-MAP for the driving path visits the driving path for the first time, it is difficult to generate the 3D HD-MAP in real time because a calculation amount for generating the HD-MAP is too large. Furthermore, since the heights of a camera and a sensor vary for each vehicle model to generate the HD-MAP having high accuracy, a variety of input data may be required. Therefore, each vehicle may give a cost to each vehicle in the group and may purchase data required for driving.

That is, if a particular vehicle has no data on a path along which it is to move, it is possible to purchase data from another vehicle. Such data may be driving data sensed based on the driving record or using a GPS. Examples of the driving data may be as follows.

1) Past Driving Information
past driving record, destination driving record

2) Fixed Surrounding Environment Information
lane information, guardrails, trees, forests, rocks, road signs, and RSU

3) Variation Information Per Observation Time
time, solar altitude, quantity of sunlight, shadow length of fixed object, traffic information

Furthermore, ECU data (e.g. information about engine RPM, brake, and wheel) unique for each vehicle manufacturer may be purchased from another vehicle while paying cost (bitcoin).

The cost of the driving data may be determined based on the following criterion.

The price of the driving data that is easily available from a plurality of vehicles may be low. Thus, the price of the driving data for a specific section with fewer driving vehicles may be high. For example, based on a traffic server, the driving data of a section having a large amount of autonomous vehicles may be purchased at a low cost, and the driving data of a section having a small amount of autonomous vehicles may be purchased at a high cost.

Such an initial charging step may receive a driving data list that may be provided by other vehicles in the group when an associated vehicle joins a first group, and may purchase required driving data.

Thereby, when there is no driving data (e.g. the latest 3D HD-MAP, sensor data) on a driving path, the autonomous vehicle may purchase the data at a cost and use the data for autonomous driving.

Purchase Method of Driving Data

A specific vehicle may request driving data on a path it needs from the vehicles in the group to the V2X. For example, when a vehicle V1 having driving data on movement from Daej eon to Seoul moves from Busan to Daej eon later, the vehicle may inquire about and request the required driving data. That is, the vehicle V1 may inquire of a vehicle V2 that has moved from Busan to Daej eon about the retention of the driving data and then request the driving data.

When the vehicle is driven on an associated section for each lane, the driving data may include a landmark on a road to be sensed, a streetlight, RSU, lane information, a solar altitude, an intensity of sunlight, a photographing time, surrounding natural environment (tree, forest, lake) depending on the quantity of corresponding sunlight, the location of an electric charging station, the location and height of a highway sign, and a physical location where the vehicle exits a highway, etc. The HD-MAP generated based on the data may be included.

In the case of sensing a path where the vehicle drives first, the generating capacity of Lidar, Radar, and an image is too large, so that it is difficult to perform calculations in real time. Furthermore, since the boundary line of the image is changed depending on the quantity of sunlight, various samples are required. Therefore, since the data on each lane may vary even when driving in the same section, sensing data on all lanes may be required.

Furthermore, since all measured sensing data is changed when the kind of a vehicle, the height of a sensor corresponding to a model, and the height of a camera are changed, it may be required to secure the driving data of the vehicle having the same vehicle model, the same camera, and the same sensor location. If the driving data is not obtained, the driving data of the vehicle having a similar specification may be required.

Therefore, even though the vehicle has driving data on an associated path, the driving data on the same path may be requested if necessary. Such an embodiment is, for example, as follows.

1) Since the same object is recognized as a different object or a different boundary line depending on the quantity of sunlight when the object is detected, an incident angle, a color temperature or the like should be recognized depending on the solar altitude for each time to detect the object. Thus, the driving data on the same path may be requested.

2) The driving data generated depending on the kind of the vehicle is the property of an automobile manufacturer, and the vehicle V1 made by another manufacturer should purchase data at a cost so as to use the data of the vehicle V2 made by another manufacturer.

If another vehicle V2 has a plurality of driving data requiring the specific vehicle V1, the specific vehicle V1 may request a plurality of driving data from another vehicle V2. Furthermore, the driving data may be purchased through the cloud server. The purchase means of the driving data may be paid in coins using the block chain.

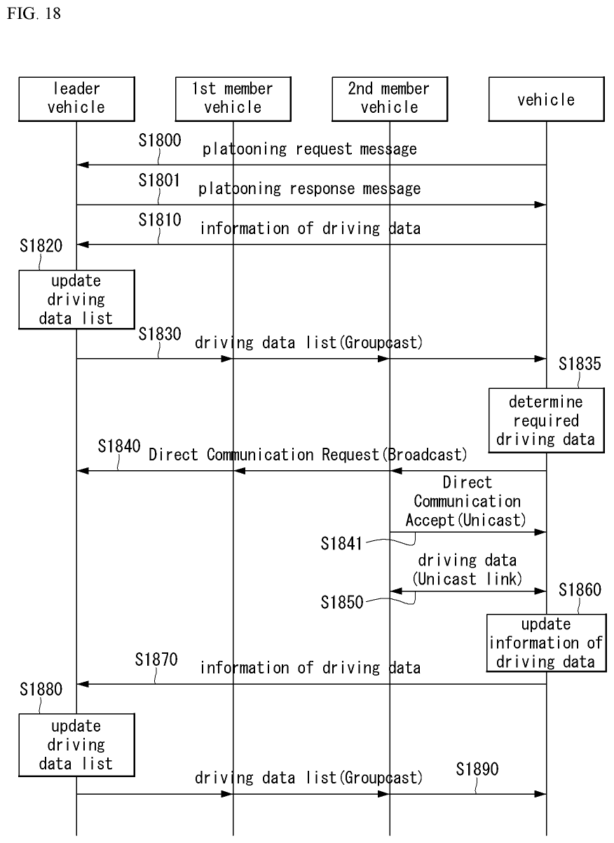

FIG. 18 is an embodiment to which the present disclosure is applicable.

A leader vehicle may perform platooning while having a first member vehicle and a second member vehicle as a member, and may manage the driving data list of the member vehicles of the group including its own driving data list. The driving data list means a list of information about the driving data for each vehicle.

The vehicle transmits a platooning request message to the leader vehicle to join an associated group at step S1800.

The leader vehicle transmits, from the vehicle, a platooning response message as a response to a platooning request message to join the vehicle in the group at step S1801.

The vehicle transmits the information of the driving data to the leader vehicle at step S1810. The information of the driving data is the information of the driving data held by the vehicle, and includes an identifier of the vehicle generating the driving data, an identifier of the driving data, a size, a type, a generating time, a generating section, and a price.

The leader vehicle updates an existing driving data list, based on the received information of the driving data at step S1820.

The leader vehicle transmits the driving data list to member vehicles of the group at step S1830. This may be composed of a group cast mode. To this end, the leader vehicle may determine a Source Layer-2 ID and a Destination Layer-2 ID instructing the member vehicles.

The vehicle determines required driving data based on the driving data list at step S1835. For example, the vehicle may confirm that the driving data on the section which the vehicle needs may be possessed by the second member vehicle.

The vehicle transmits an immediate communication request message using Broadcast to establish a Unicast link for receiving the driving data at step S1840. The immediate communication request message includes Target User Info about the second member vehicle, and the identifier of the driving data required by the vehicle may be included.

The second member vehicle transmits an immediate communication acceptance message to the vehicle using the Unicast in response to the immediate communication request message at step S1841.

The vehicle may receive the driving data from the second member vehicle through the established Unicast link at step S1850. Furthermore, in this process, the associated driving data can be purchased through a coin using block chain technology, and a coin payment operation may be performed.

The vehicle may generate driving data of good quality, based on the received driving data, and may update the changed information of driving data at step S1860.

The vehicle transmits the updated information of driving data to the leader vehicle at step S187.

The leader vehicle updates the driving data list based on the received information of driving data of the vehicle at step S1880.

The leader vehicle transmits the driving data list to share the updated driving data list with member vehicles at step S1890.

Through the above-mentioned operation, the vehicles in the group may exchange driving data, may share the information of the driving data, and may pay the coin using the block chain if necessary. Furthermore, the above-described operations can be efficiently performed by applying communication modes through PC5 defined in 3GPP.

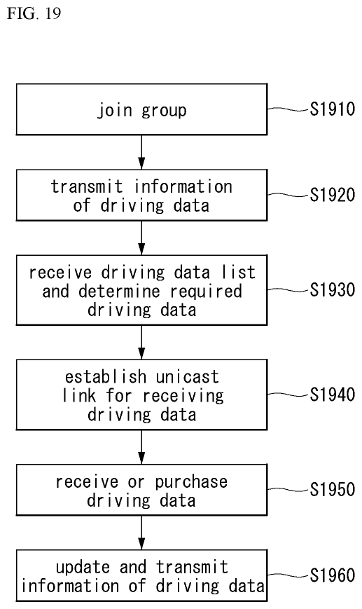

FIG. 19 is an embodiment of a vehicle to which the present disclosure is applicable.

The vehicle joins to a group during platooning. To this end, the platooning request message may be transmitted to the leader vehicle, and the platooning response message may be received from the leader vehicle at step S1910.

The vehicle transmits its information of driving data to the leader vehicle at step S1920.

The vehicle receives the driving data list generated or updated by the leader vehicle, and determines the driving data required in an associated vehicle at step S1930. This may be automatically determined by an application of the vehicle, and may be performed by displaying the driving data list to the user through the display of the vehicle, and inputting the selection of required driving data from the user.

The vehicle performs the Unicast link establishment with the vehicle having the associated driving data, so as to receive the required driving data at step S1940.

The vehicle may receive the driving data through the Unicast link or may purchase the associated driving data with the coin using the block chain, at step S1950.

The vehicle updates the information of driving data based on the received driving data, and transmits the updated information of driving data to the leader vehicle, so as to update the driving data list of the leader vehicle at step S1960.

General Device to which the Present Disclosure is Applicable

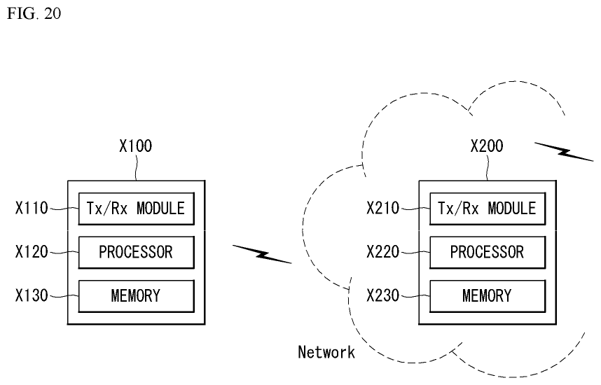

Referring to FIG. 20, a server X200 according to an embodiment may be an MEC server or a cloud server, and may include a communication module X210, a processor X220, and a memory X230. The communication module X210 is referred to as a radio frequency (RF) unit. The communication module X210 may be configured to transmit various signals, data and information to an external device and to receive various signals, data and information from the external device. The server X200 may be connected to an external device by wire and/or wirelessly. The communication module X210 may be separated into a transmitter and a receiver. The processor X220 may control the entire operation of the server X200, and may be configured so that the server X200 performs the function of calculating information that is to be transmitted to and received from the external device. Furthermore, the processor X220 may be configured to perform the operation of the server according to the present disclosure. The processor X220 may control the communication module X210 to transmit data or the message to the UE, another vehicle and another server according to the present disclosure. The memory X230 may store the calculated information for a predetermined time, and may be replaced by a component such as a buffer.

Furthermore, the detailed description of the above-described terminal equipment X100 and the server X200 may be implemented by independently applying various embodiments of the present disclosure or simultaneously applying two or more embodiments. A duplicated description will be omitted herein for clarity.

### EMBODIMENTS TO WHICH THE PRESENT DISCLOSURE IS APPLICABLE

### Embodiment 1

A method of receiving driving data in platooning in an autonomous driving system, including:

transmitting a platooning request message to a leader vehicle of a group in which a vehicle is to join; receiving a platooning response message as a response to the platooning request message; transmitting information of the driving data to the leader vehicle; and receiving a list of the driving data related to vehicles of the group from the leader vehicle,

wherein the list instructs the information of the driving data that may be transmitted by the vehicles of the group, and the information of the driving data includes an identifier of the vehicle generating the driving data, an identifier of the driving data, and a generating section.

### Embodiment 2

The method of embodiment 1,

wherein the leader vehicle transmits the list through a Groupcast to member vehicles of the group.

### Embodiment 3

The method of embodiment 1, further including:

determining required driving data based on the list; establishing an Unicast link based on the required driving data; and receiving the required driving data through the Unicast link,

wherein the Unicast link is established by forming a Peer with a transmission vehicle that may transmit the required driving data.

### Embodiment 4

The method of embodiment 3,

wherein the establishing of the Unicast link is established by transmitting a communication request message including the identifier of the transmission vehicle through a Broadcast, and responding to the communication request message through a Unicast by the transmission vehicle.

### Embodiment 5

The method of embodiment 3,

wherein the receiving of the required driving data is performed by giving a coin related to a block chain to the transmission vehicle.

### Embodiment 6

The method of embodiment 3, further including:

updating the information of the driving data based on the required driving data, wherein the vehicle updates the driving data using the required driving data.

### Embodiment 7

The method of embodiment 3,

wherein the determining of the required driving data is performed by displaying the list on a display and accepting selection of the required driving data from a user.

### Embodiment 8

The method of embodiment 6, further including:

transmitting the updated driving data information to the leader vehicle, wherein the leader vehicle updates the list based on the updated driving data information.

### Embodiment 9

The method of embodiment 5,

wherein a number of coins is based on the generating section.

### Embodiment 10

The method of embodiment 2,

wherein the leader vehicle determines a Source Layer-2 ID and a Destination Layer-2 ID instructing the member vehicles.

### Embodiment 11

A vehicle for performing a method of receiving driving data in platooning in an autonomous driving system including a communication module; a display; a memory; and a processor configured to control the communication module, the display and the memory,

wherein the processor transmits a platooning request message to a leader vehicle of a group in which a vehicle is to join, receives a platooning response message as a response to the platooning request message, transmits information of the driving data to the leader vehicle, and receives a list of the driving data related to vehicles of the group from the leader vehicle, through the communication module, wherein the list instructs the information of the driving data that may be transmitted by the vehicles of the group, and the information of the driving data comprises an identifier of the vehicle generating the driving data, an identifier of the driving data, and a generating section.

### Embodiment 12

The vehicle of embodiment 11,

wherein the leader vehicle transmits the list through a Groupcast to member vehicles of the group.

### Embodiment 13

The vehicle of embodiment 11,

wherein the processor determines required driving data based on the list, establishes an Unicast link based on the required driving data, and receives the required driving data through the Unicast link using the communication module,

wherein the Unicast link is established by forming a Peer with a transmission vehicle that may transmit the required driving data.

### Embodiment 14

The vehicle of embodiment 13,

wherein the Unicast link is established by transmitting a communication request message including the identifier of the transmission vehicle through a Broadcast, and responding to the communication request message through a Unicast by the transmission vehicle.

### Embodiment 15

The vehicle of embodiment 13,

wherein the required driving data is received by giving a coin related to a block chain to the transmission vehicle.

### Embodiment 16

The vehicle of embodiment 13,

wherein the processor updates the information of the driving data based on the required driving data, and the vehicle updates the driving data using the required driving data.

### Embodiment 17

The vehicle of embodiment 13,

wherein the required driving data is determined by displaying the list on the display and accepting selection of the required driving data from a user.

### Embodiment 18

The vehicle of embodiment 16,

wherein the processor transmits the updated driving data information to the leader vehicle through the communication module, and the leader vehicle updates the list based on the updated driving data information.

### Embodiment 19

The vehicle of embodiment 15,

wherein a number of coins is based on the generating section.

### Embodiment 20

The vehicle of embodiment 12,

wherein the leader vehicle determines a Source Layer-2 ID and a Destination Layer-2 ID instructing the member vehicles.

The above-described present disclosure may be embodied as a computer readable code on a medium on which a program is recorded. The computer readable medium includes all kinds of recording devices in which data that can be read by the computer system is stored. Examples of the computer readable medium include Hard Disk Drives (HDD), Solid State Disks (SSD), Silicon Disk Drives (SDD), ROMs, RAMs, CD-ROMs, magnetic tapes, floppy disks, optical data storages and others. Furthermore, the computer readable medium may be embodied in the form of a carrier wave (e.g. transmission via the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

While the present disclosure has been described with reference to exemplary embodiments thereof, it is to be understood by those skilled in the art that various changes and modifications may be made without departing from the spirit and scope of the invention. For example, components that are described in the embodiments in detail may be modified. Furthermore, differences related to these changes and modifications should be construed as being included in the scope of the present disclosure defined in the appended claims.

Although the present disclosure has been described with an example where it is applied to an autonomous driving system (Automated Vehicle & Highway Systems) based on a 5G (5 generation) system, the disclosure may be applied to various wireless communication systems and autonomous driving devices.

What is claimed is:

1. A method of receiving driving data in platooning in an autonomous driving system, comprising:
transmitting a platooning request message to a leader vehicle of a platoon in which a vehicle is to join;
receiving a platooning response message as a response to the platooning request message;
transmitting information of the driving data to the leader vehicle; and
receiving a list of the driving data related to vehicles of the platoon from the leader vehicle,
wherein the list instructs the information of the driving data that may be transmitted by the vehicles of the platoon, and the information of the driving data comprises an identifier of the vehicle generating the driving data, an identifier of the driving data, and a generating section.

2. The method of claim 1, wherein the leader vehicle transmits the list through a Groupcast to member vehicles of the platoon.

3. The method of claim 1, further comprising:
determining required driving data based on the list;
establishing an Unicast link based on the required driving data; and
receiving the required driving data through the Unicast link,
wherein the Unicast link is established by forming a Peer with a transmission vehicle that may transmit the required driving data.

4. The method of claim 3, wherein the establishing of the Unicast link is established by transmitting a communication request message including the identifier of the transmission vehicle through a Broadcast, and responding to the communication request message through a Unicast by the transmission vehicle.

5. The method of claim 3, wherein the receiving of the required driving data is performed by giving a coin related to a block chain to the transmission vehicle.

6. The method of claim 3, further comprising:
updating the information of the driving data based on the required driving data,
wherein the vehicle updates the driving data using the required driving data.

7. The method of claim 3, wherein the determining of the required driving data is performed by displaying the list on a display and accepting selection of the required driving data from a user.

8. The method of claim 6, further comprising:
transmitting the updated driving data information to the leader vehicle,
wherein the leader vehicle updates the list based on the updated driving data information.

9. The method of claim 5, wherein a number of coins is based on the generating section.

10. The method of claim 2, wherein the leader vehicle determines a Source Layer-2 ID and a Destination Layer-2 ID instructing the member vehicles.

11. A vehicle for performing a method of receiving driving data in platooning in an autonomous driving system, the vehicle comprising:
a transceiver;
a display;
a memory; and
a processor configured to control the transceiver, the display and the memory,
wherein the processor transmits a platooning request message to a leader vehicle of a platoon in which a vehicle is to join, receives a platooning response message as a response to the platooning request message, transmits information of the driving data to the leader vehicle, and receives a list of the driving data related to vehicles of the platoon from the leader vehicle, through the transceiver,
wherein the list instructs the information of the driving data that may be transmitted by the vehicles of the platoon, and the information of the driving data comprises an identifier of the vehicle generating the driving data, an identifier of the driving data, and a generating section.

12. The vehicle of claim 11, wherein the leader vehicle transmits the list through a Groupcast to member vehicles of the platoon.

13. The vehicle of claim 11, wherein the processor determines required driving data based on the list, establishes an Unicast link based on the required driving data, and receives the required driving data through the Unicast link using the transceiver,
wherein the Unicast link is established by forming a Peer with a transmission vehicle that may transmit the required driving data.

14. The vehicle of claim 13, wherein the Unicast link is established by transmitting a communication request message including the identifier of the transmission vehicle through a Broadcast, and responding to the communication request message through a Unicast by the transmission vehicle.

15. The vehicle of claim 13, wherein the required driving data is received by giving a coin related to a block chain to the transmission vehicle.

16. The vehicle of claim 13, wherein the processor updates the information of the driving data based on the required driving data, and the vehicle updates the driving data using the required driving data.

17. The vehicle of claim 13, wherein the required driving data is determined by displaying the list on the display and accepting selection of the required driving data from a user.

18. The vehicle of claim 16, wherein the processor transmits the updated driving data information to the leader vehicle through the transceiver, and the leader vehicle updates the list based on the updated driving data information.

19. The vehicle of claim 15, wherein a number of coins is based on the generating section.

20. The vehicle of claim 12, wherein the leader vehicle determines a Source Layer-2 ID and a Destination Layer-2 ID instructing the member vehicles.
